(19) United States
(12) Patent Application Publication
(10) Pub. No.: US 2008/0193808 A1
(43) Pub. Date: Aug. 14, 2008

(54) Reacting apparatus and electronic device comprising thereof

(75) Inventor: Tadao Yamamoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/012,756

(22) Filed: Feb. 5, 2008

(30) Foreign Application Priority Data
Feb. 8, 2007 (JP) PATENT2007-029215

(51) Int. Cl. H01M 8/06; H01M 8/10

(52) U.S. Cl. 429/20; 429/34; 429/30; 429/26

(57) ABSTRACT

Disclosed is a reacting apparatus including: a reactor including a reacting section to which a reactant is supplied to cause a reaction of the reactant; one or a plurality of terminal section provided in the reacting section; and one or a plurality of conductive component including electrically conductive material, one end of which is connected to any one of the terminal section of the reactor, wherein at least one of the conductive component has a flow path provided inside thereof; and at least a portion of the reactant is supplied to the reactor through the flow path. Consequently, rise in temperature of an other end of the electrically conductive component due to heat transmission from the reactor can be suppressed and heat loss of the reactor through the electrically conductive component may be reduced.

### BACKGROUND OF THE INVENTION

1. Field of the Invention

The present invention relates to a reacting apparatus in which a reactant is supplied and a reaction of the reactant is caused, and an electronic device comprising the reacting apparatus.

2. Description of the Related Art

Recently, fuel cells are attracting attention as a clean power source with high energy conversion efficiency, and are applied widely in fuel cell powered vehicles, electric homes, etc. The application of fuel cells as power sources are also considered in portable electronic devices such as cellular phones and lap top computers, where research and development of size reduction are rapidly proceeding, due to the increase in power consumption.

A fuel cell includes a power generating cell which outputs electric power with an electrochemical reaction of hydrogen and oxygen. Research and development of fuel cells are being widely done as a main stream power source system of the next generation. Especially, solid oxide fuel cells (hereinafter referred to as SOFC) are being developed, since SOFC has high power generation efficiency due to high temperature operation. The SOFC includes a power generating cell in which a fuel electrode is formed on one face of a solid oxide electrolyte and an oxygen electrode is formed on the other face.

In the SOFC, since the operation temperature of the power generating cell is high, the heat of the power generating cell is propagated to an anode output electrode and a cathode output electrode connected to the power generating cell, and the temperature of the anode output electrode and the cathode output electrode rises. Thus, mounting the SOFC into an electronic device is difficult. Also, the heat of the output electrode transmits to the heat insulating container accommodating the power generating cell, and the temperature of the heat insulating container rises, resulting in the possibility of increase in heat loss.

### SUMMARY OF THE INVENTION

The present invention has been made in consideration of the above situation, and in a reacting apparatus comprising a reactor causing a reaction of a supplied reactant, has an advantage of suppressing rise in temperature of a electrically conductive component connected to a reactor due to heat transmission from the reactor in order to easily mount the reacting apparatus in an electronic device and to reduce heat loss through the electrically conductive component.

In order to achieve any one of the above advantages, a first reacting apparatus of the present invention comprises:

a reactor including a reacting section to which a reactant is supplied to cause a reaction of the reactant;

one or a plurality of terminal section provided in the reacting section; and

one or a plurality of conductive component including electrically conductive material, one end of which is connected to any one of the terminal section of the reactor,

wherein

at least one of the conductive component has a flow path provided inside thereof; and

at least a portion of the reactant is supplied to the reactor through the flow path.

In order to achieve any one of the above advantages, a second reacting apparatus of the present invention comprises:

a heat insulating container in which a pressure inside is lower than atmospheric pressure;

a reactor which is accommodated in the heat insulating container and including a reacting section to which a reactant is supplied to cause a reaction of the reactant;

one or a plurality of terminal section provided in the reacting section; and

one or a plurality of conductive component including electrically conductive material, one end of the conductive component being connected to any one of the terminal section of the reactor and the other end is drawn outside from a wall surface of the heat insulating container,

wherein

at least one of the conductive component has a flow path provided inside thereof; and

at least a portion of the reactant is supplied to the reactor through the flow path.

In order to achieve any one of the above advantages, an electronic device of the present invention comprises:

a power generating cell to which fuel and an oxidizing agent is supplied to generate electric power with an electrochemical reaction of the fuel and the oxidizing agent, and which includes a positive output terminal and a negative output terminal to output the generated electric power;

a plurality of output electrodes to output electric power generated in the power generating cell, each of which includes electrically conductive material, one end of each of which is connected to the positive output terminal or the negative output terminal; and

a load driven by the electric power output from the output electrodes, wherein

at least one of the output electrodes has a flow path provided inside thereof to supply at least one of the fuel and the oxidizing agent to the power generating cell.

### BRIEF DESCRIPTION OF THE DRAWINGS

The present invention and the above-described objects, features and advantages thereof will become more fully understood from the following detailed description with the accompanying drawings and wherein;

FIG. 1 is a block diagram showing an electronic device equipped with a reacting apparatus of the first embodiment;

FIG. 2 is a schematic view showing a power generating cell;

FIG. 3 is a schematic view showing an example of a power generating cell stack;

FIG. 4 is a perspective view showing a heat insulating package of the present embodiment;

FIG. 5 is a perspective view showing an inner structure of the heat insulating package of the present embodiment;

FIG. 6 is a perspective view showing an inner structure of the heat insulating package shown in FIG. 5 viewed from a bottom side;

FIG. 7 is a cross-sectional view taken along arrows VII-VII shown in FIG. 4;

FIG. 8 is a bottom view showing a coupling section, a reformer, a coupling section and a fuel cell section;

FIG. 9 is a cross-sectional view taken along arrows IX-IX shown in FIG. 8 FIG. 10 is a cross-sectional view taken along arrows X-X shown in FIG. 9.

FIG. 11 is a perspective view showing a structure of only an anode output electrode, a cathode output electrode and a power generating cell;

FIG. 12 is a cross-sectional view taken along arrows XII-XII shown in FIG. 11.

FIG. 13 is a schematic view showing a temperature distribution inside a heat insulating package during normal operation.

FIG. 14 is a perspective view showing a first modification of an inner structure of the heat insulating package;

FIG. 15 is a perspective view showing an inner structure of the heat insulating package shown in FIG. 14 viewed from the bottom side;

FIG. 16 is a perspective view showing a second modification of an inner structure of the heat insulating package;

FIG. 17 is a perspective view showing a third modification of an inner structure of the heat insulating package;

FIG. 18 is a perspective view showing an inner structure of the heat insulating package of the second embodiment of the present invention; and

FIG. 19 is a perspective view showing an inner structure of the heat insulating package of the third embodiment of the present invention.

### DETAILED DESCRIPTION OF THE PREFERRED EMBODIMENTS

A reforming apparatus of the present embodiment and an electronic device comprising thereof will be described in detail with reference to the drawings. The embodiments described below include various technically preferable limitations for carrying out the present invention, however, the scope of the invention is not limited to the embodiments and the illustrated examples.

### First Embodiment

First, a reacting apparatus of the first embodiment of the present invention and an electronic device comprising thereof will be described.

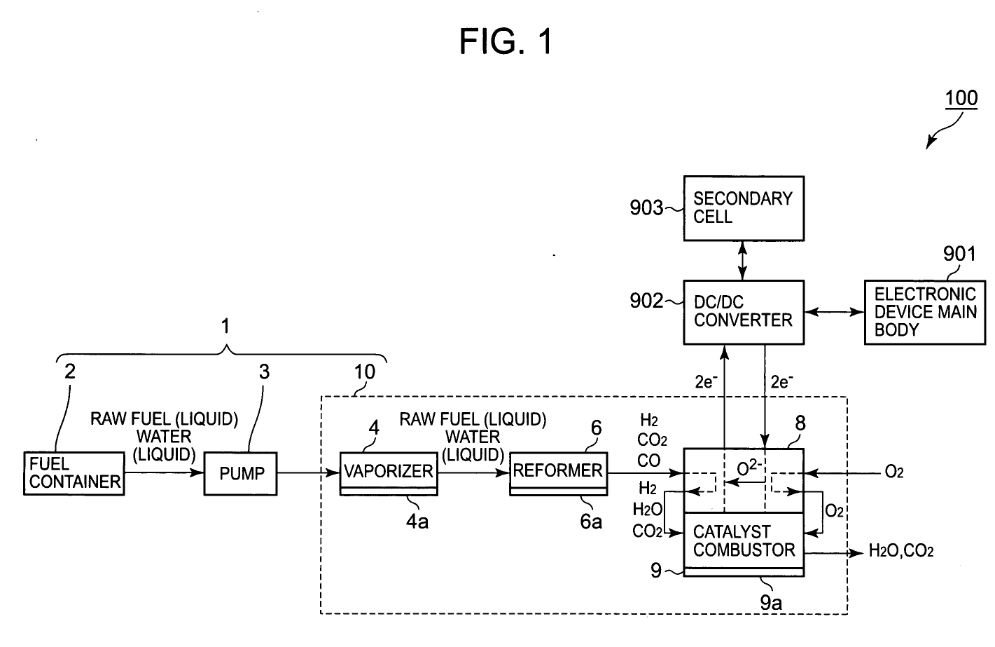

FIG. 1 is a block diagram showing an electronic device equipped with the reacting apparatus of the first embodiment of the present invention.

This electronic device 100 is a portable electronic device, such as a lap top computer, PDA, electronic organizer, digital camera, cellular phone, watch, resister and projector.

The electronic device 100 comprises an electronic device main body 901, a DC/DC converter 902, a secondary cell 903, etc., and a reacting apparatus 1.

The electronic device main body 901 is driven by electric power supplied from the DC/DC converter 902 or the secondary cell 903. The DC/DC converter 902 converts the electric energy generated by the reacting apparatus 1 to a suitable voltage, and then supplies the energy to the electronic device main body 901. The DC/DC converter 902 also charges the secondary cell 903 with the electric energy generated in the reacting apparatus 1, and when the reacting apparatus 1 is not operating, supplies the electric energy charged in the secondary cell 903 to the electronic device main body 901.

The reacting apparatus 1 of this embodiment comprises a fuel container 2, a pump 3, a heat insulating package 10 and the like. The fuel container 2 of the reacting apparatus 1 is for example, removably provided in the electronic device 100, and the pump 3 and the heat insulating package 10 are for example, integrated in the main body of the electronic device 100.

A liquid mixture of liquid raw fuel (for example, methanol, ethanol and dimethyl ether) and water is stored in the fuel container 2. The liquid raw fuel and the water may be stored in separate containers.

The pump 3 draws the liquid mixture into the fuel container 2 and sends the liquid mixture to a vaporizer 4 in the heat insulating package 10.

The vaporizer 4, a reformer 6, a power generating cell 8 and a catalytic combustor 9 are provided in the heat insulating package 10. Pressure of an inner space of the heat insulating package 10 is maintained lower than the atmospheric pressure which is vacuum pressure (for example, no more than 10 Pa).

Electric heaters cum temperature sensors 4a, 6a and 9a are provided in the vaporizer 4, reformer 6 and catalytic combustor 9, respectively. Since electric resistance values of the electric heaters cum temperature sensors 4a, 6a and 9a depend on the temperature, these electric heaters cum temperature sensors 4a, 6a and 9a function as temperature sensors for measuring the temperatures of the vaporizer 4, the reformer 6 and the catalytic combustor 9.

The liquid mixture sent from the pump 3 to the vaporizer 4 is heated to about 110-160° C. with heat of the electric heater cum temperature sensor 4a or heat propagated from the catalytic combustor 9 and vaporized. The gas mixture vaporized in the vaporizer 4 is sent to the reformer 6.

A flow path is formed inside the reformer 6 and a catalyst is supported on the wall surface of the flow path. The gas mixture sent from the vaporizer 4 to the reformer 6 passes through the flow path of the reformer 6 and is heated to about 300-400° C. with the heat from the electric heater cum temperature sensor 6a, reaction heat from the power generating cell 8 or the heat from the catalytic combustor 9 and a reforming reaction is caused by the catalyst. The reforming reaction of the raw fuel and water generates a gas mixture (reformed gas) including hydrogen and carbon dioxide which serve as fuel and a trace amount of carbon monoxide which is a by-product. When the raw fuel is methanol, mainly a steam reforming reaction shown in the following formula (1) occurs in the reformer 6.

CH₃OH+H₂O→3H₂+CO_{2 . . .} (1)

A trace amount of carbon monoxide is generated as a by-product as shown in the following formula (2) which occurs subsequent to the reaction shown in chemical reaction formula (1)

H₂+CO₂→H₂O+CO (2)

The gas (reformed gas) generated by the chemical reaction formulas (1) and (2) is sent to the power generating cell 8.

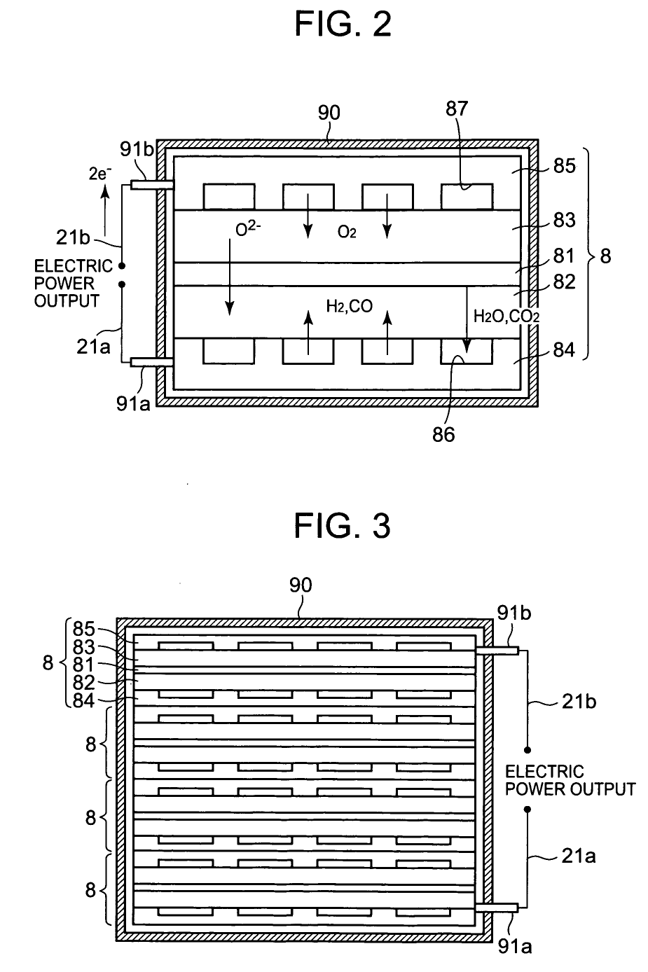

FIG. 2 is a schematic view of the power generating cell.

FIG. 3 is a schematic view showing an example of a power generating cell stack.

As shown in FIG. 2, the power generating cell 8 comprises a solid oxide electrolyte 81, a fuel electrode 82 (anode) and an oxygen electrode 83 (cathode) formed on both sides of the solid oxide electrolyte 81, an anode collecting electrode 84 joined to the fuel electrode 82 including a flow path 86 formed facing the joining surface and a cathode collecting electrode 85 joined to the oxygen electrode 83 including a flow path 87 formed facing the joining surface. The power generating cell 8 is accommodated in the box-shaped case 90.

The anode collecting electrode 84 includes a positive output terminal 91a and one end of the anode output electrode (electrically conductive component) 21a including electrically conductive material is connected to the positive output terminal 91a. The cathode collecting electrode 85 includes a negative output terminal 91b and one end of the cathode output electrode (electrically conductive component) 21b including electrically conductive material is connected to the negative output terminal 91b. The other ends of the anode output electrode 21a and the cathode output electrode 21b penetrate through the box-shaped case 90 and are drawn outside. As described later, the box-shaped case 90 is formed with for example, a Ni-based alloy and the other ends of the anode output electrode 21a and the cathode output electrode 21b are drawn out insulated from the box-shaped case 90 by insulating material such as glass and ceramics. As shown in FIG. 1, the anode output electrode 21a and the cathode output electrode 21b are connected to for example, the DC/DC converter 902.

As the solid oxide electrolyte 81, zirconia-type (Zr₁₋ₓYₓ)O_{2-x/2}(YSZ), lanthanum gallate-type (La₁₋ₓSrₓ) (Ga_{1-y-z}Mg_{y}CO_{z})O₃, etc., as the fuel electrode 82, La_{0.84}Sr_{0.16}MnO₃, La(Ni, Bi)O₃, (La, Sr)MnO₃, In₂O₃+SnO₂, LaCoO₃, etc., as the oxygen electrode 83, Ni, Ni+YSZ, etc., and as the anode collecting electrode 84 and the cathode collecting electrode 85 LaCr(Mg)O₃, (La,Sr)CrO₃, NiAl+Al₂O₃ etc., may be used, respectively.

The power generating cell 8 is heated to about 500-1000° C. with heat from the electric heater cum temperature sensor 9a or the catalytic combustor 9 and a later described reaction occurs.

Air (oxygen: oxidizing agent) is sent to the oxygen electrode 83 through the flow path 87 of the cathode collecting electrode 85. In the oxygen electrode 83, oxygen ion is generated as shown in the following formula (3) with oxygen and an electron supplied from the cathode output electrode 21b.

O₂+4e⁻→2O²⁻ (3)

The solid oxide electrolyte 81 is permeable to oxygen ion, and the oxygen ion generated in the oxygen electrode 83 as shown in the chemical reaction formula (3) permeates to the fuel electrode 82.

The reformed gas discharged from the reformer 6 is sent to the fuel electrode 82 through the flow path 86 of the anode collecting electrode 84. In the oxygen electrode 83, a reaction shown in the following formulas (4) and (5) occur between the oxygen ion permeated through the solid oxide electrolyte 81 and the reformed gas.

H₂+O²⁻→H₂O+2e⁻ (4)

CO+O²⁻→CO₂+2e⁻ (5)

The electron released as shown in the chemical reaction formulas (4) and (5) passes through the outer circuit such as the fuel electrode 82, the anode output electrode 21a, the DC/DC converter 902, etc. and is supplied to the oxygen electrode 83 from the cathode output electrode 21b.

As shown in FIG. 3, a plurality of power generating cells 8 including an anode collecting electrode 84, a fuel electrode 82, a solid oxide electrolyte 81, an oxygen electrode 83, and a cathode collecting electrode 85 may be serially connected to form a cell stack 80. As shown in FIG. 3, an anode collecting electrode 84 of a power generating cell 8 at one end of the serially connected power generating cells is connected to the anode output electrode 21a and a cathode collecting electrode 85 of a power generating cell 8 at the other end of the serially connected power generating cells is connected to the cathode output electrode 21b. The cell stack 80 is accommodated in a box-shaped case 90.

The reformed gas (offgas) which is passed through the flow path of the anode collecting electrode 84 includes unreacted hydrogen. The offgas is supplied to the catalytic combustor 9.

The offgas and the air which is passed through the flow path 87 of the cathode collecting electrode 85 are supplied to the catalytic combustor 9. A flow path is formed inside the catalytic combustor 9 and a Pt-type catalyst is supported on the wall surface of the flow path.

An electric heater cum temperature sensor 9a including an electro-thermal material is provided in the catalytic combustor 9. Since electric resistance value of the electric heater cum temperature sensor 9a depends on the temperature, this electric heater cum temperature sensor 9a also functions as a temperature sensor for measuring the temperature of the catalytic combustor 9.

The mixture gas (combustion gas) of the offgas and air flows through the flow path of the catalytic combustor 9 and is heated by the electric heater cum temperature sensor 9a. Among the combustion gas flowing through the flow path of the catalytic combustor 9, hydrogen is combusted by the catalyst and combustion heat is generated. The discharged gas after the combustion is released outside the heat insulating package 10 from the catalytic combustor 9.

The combustion heat generated from the catalytic combustor 9 is used for maintaining the temperature of the power generating cell 8 to a high temperature (about 500-1000° C.). The heat of the power generating cell 8 is transmitted to the reformer 6 and the vaporizer 4 and is used for the vaporizing in the vaporizer 4 and the vapor reforming reaction in the reformer 6.

Next, the specific structure of the heat insulating package 10 will be described.

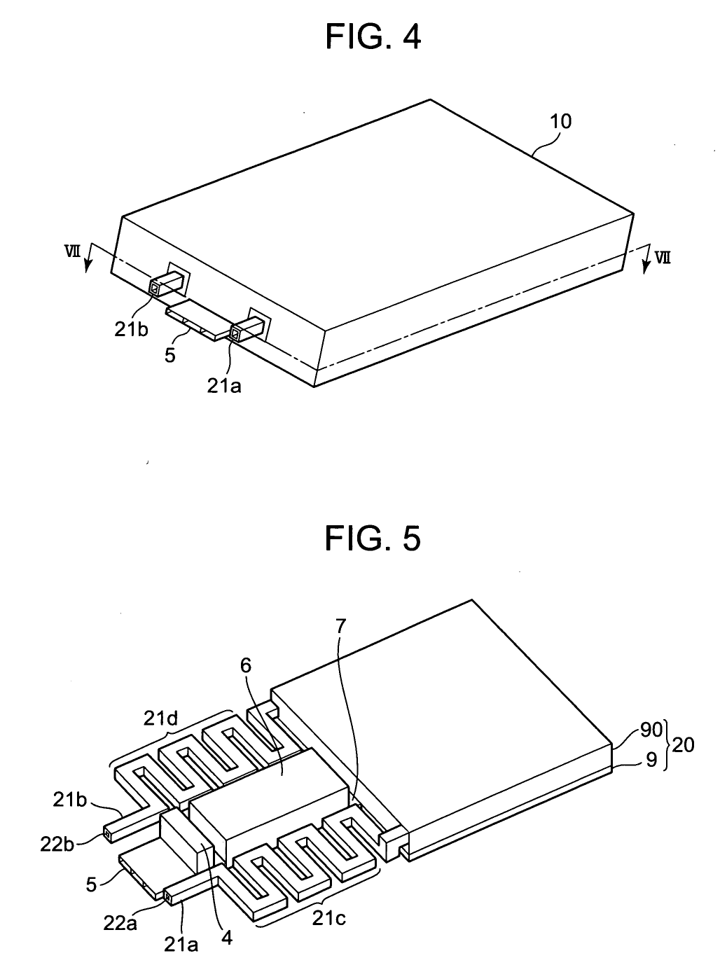

FIG. 4 is a perspective view showing the heat insulating package of the present embodiment.

FIG. 5 is a perspective view showing an inner structure of the heat insulating package of the present embodiment.

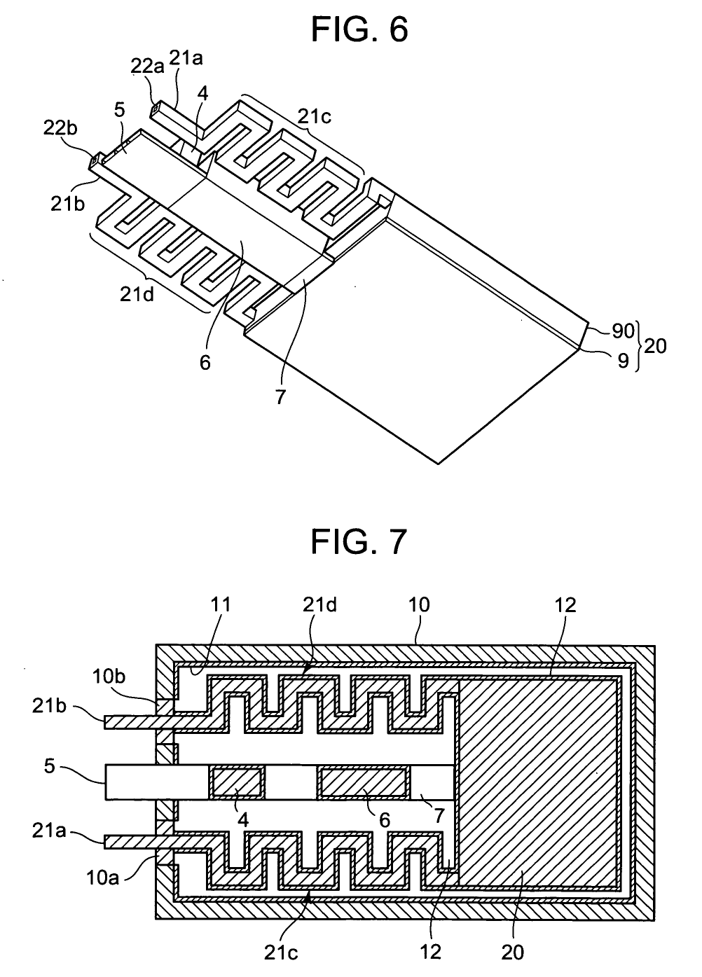

FIG. 6 is a perspective view showing the inner structure of the heat insulating package shown in FIG. 5 from a bottom view.

FIG. 7 is a cross-sectional view taken along arrows VII-VII of FIG. 4.

As shown in FIG. 4, a coupling section 5, the anode output electrode 21a, and the cathode output electrode 21b protrude from one of the wall surfaces of the heat insulating package 10.

As shown in FIG. 7, the penetrating sections of the anode output electrode 21a and the cathode output electrode 21b of the heat insulating package 10 are insulated by insulating materials 10a and 10b.

As shown in FIG. 5-FIG. 7, in the heat insulating package 10 of the present embodiment, the vaporizer 4, the coupling section 5, the reformer 6, a coupling section 7 and the fuel cell section 20 are positioned in this order. The fuel cell section 20 include the box-shaped case 90 accommodating the power generating cell 8 and the catalytic combustor 9 formed integrally and the off gas from the fuel electrode 82 of the power generating cell 8 is supplied to the catalytic combustor 9.

The vaporizer 4, the coupling section 5, the reformer 6, the coupling section 7, the box-shaped case 90 storing the power generating cell 8 of the fuel cell section 20 and the catalytic combustor 9 and the anode output electrode 21a and the cathode output electrode 21b include a metal with high temperature durability and a moderate thermal conductivity, and for example, a Ni-based alloy such as inconel 783 can be used. Especially, in order to prevent the damage of the anode output electrode 21a and the cathode output electrode 21b, which are connected to the anode collecting electrode 84 and the cathode collecting electrode 85 of the fuel cell section 20 and drawn out from the box-shaped case 90, by receiving stress due to a difference in coefficient of thermal expansion with the rise in temperature of the power generating cell 8, it is preferable that at least the anode output electrode 21a and the cathode output electrode 21b are formed with the same material as the box-shaped case 90. It is preferable that the vaporizer 4, the coupling section 5, the reformer 6, the coupling section 7, and the box-shaped case 90 and the catalytic combustor 9 of the fuel cell section 20 are formed with the same material in order to reduce the stress generated among them with the rise in temperature.

A radiation preventing film 11 is formed on the inner wall surface of the heat insulating package 10 and a radiation preventing film 12 is formed on the outer wall surface of the vaporizer 4, the coupling section 5, the reformer 6, the coupling section 7, the anode output electrode 21a, the cathode output electrode 21b and the fuel cell section 20. The radiation preventing films 11 and 12 suppress the transmission of heat due to radiation, and material such as Au, Ag, etc., may be used. It is preferable that at least one of the radiation preventing films 11 or 12 is provided, and it is more preferable to provide both.

The coupling section 5 penetrates the heat insulating package 10, and one end is connected to the pump 3 outside the heat insulating package 10 and the other end is connected to the reformer 6 and a vaporizer 4 is provided in a section in between. The reformer 6 and the fuel cell section 20 are connected to each other with a coupling section 7.

As shown in FIG. 5 and FIG. 6, the vaporizer 4, the coupling section 5, the reformer 6, the coupling section 7 and the fuel cell section 20 are formed integrally and the bottom surface forms one face.

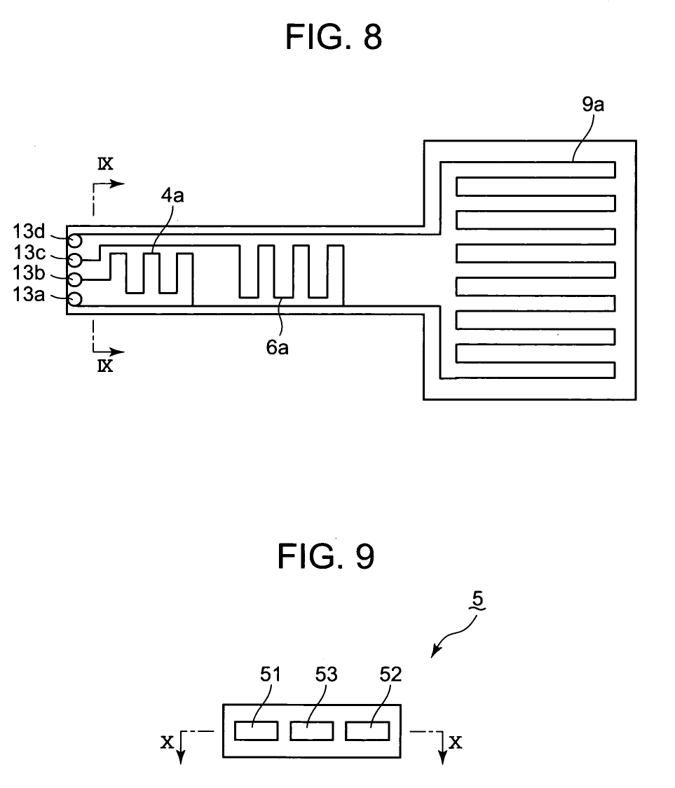

FIG. 8 is a bottom view of the coupling section 5, the reforming section 6, the coupling section 7, and the fuel cell section 20.

In FIG. 8, the anode output electrode 21a and the cathode output electrode 21b are omitted. As shown in FIG. 8, on the bottom face of the coupling section 5, the reformer 6, the coupling section 7, and the fuel cell section 20, after insulating processing with ceramics, etc., wiring patterns 13 are formed. The wiring patterns 13 are formed in a serpentine shape in the bottom section of the vaporizer 4, the reformer 6 and the fuel cell section 20 and serve as electric heaters cum temperature sensors 4a, 6a and 9a, respectively. The electric heaters cum temperature sensors 4a, 6a and 9a are connected to a common terminal 13a at one end, and are connected to three independent terminals 13b, 13c and 13d respectively at the other end. These four terminals 13a, 13b, 13c and 13d are formed at an end section on the outer side of the coupling section 5 of the heat insulating package 10.

FIG. 9 is a cross-sectional view taken along arrows IX-IX of FIG. 8.

FIG. 10 is a cross-sectional view taken along arrows X-X of FIG. 9.

In the coupling section 5, exhaust flow paths 51 and 52 are provided for the exhaust gas discharged from the catalytic combustor 9. In the coupling section 5, a supply flow path 53 is provided for the liquid mixture sent from the pump 3 to the vaporizer 4 and the gas fuel sent to the reformer 6 from the vaporizer 4.

Similarly, in the coupling section 7, an exhaust flow path (not shown) in communication with the exhaust flow paths 51 and 52 for the exhaust gas discharged from the catalytic combustor 9 is provided. In the coupling section 7, a supply flow path (not shown) for the reformed gas sent from the reformer 6 to the fuel electrode 82 of the power generating cell 8 is provided. The supply flow path of the raw fuel, the fuel and the reformed gas to the vaporizer 4, the reformer 6 and the fuel cell section 20 and the exhaust flow path for the exhaust gas are provided by the coupling sections 5 and 7.

In order to make the diameter of the flow path for exhaust gas discharged from the catalytic combustor 9 large enough compared to the offgas and the air supplied to the catalytic combustor 9, among the three flow paths provided inside the coupling section 7, two are used as flow paths for exhaust gas from the catalytic combustor 9 and the other one is used for the supply flow path of the reformed gas to the fuel electrode 82 of the power generating cell 8.

As shown in FIG. 5 and FIG. 6, one end of the anode output electrode 21a and the cathode output electrode 21b are drawn out from the face on the side connected to the coupling section 7 of the fuel cell section 20. As shown in FIG. 4, the other end of the anode output electrode 21a and the cathode output electrode 21b protrude outside from the same wall surface as the wall surface from which the coupling section 5 of the heat insulating package 10 protrudes.

In the present embodiment, the coupling section 7 is connected to the central area of one face of the fuel cell section 20, and the anode output electrode 21a and the cathode output electrode 21b are drawn out from the diagonal areas on the same face. Thus, the fuel cell section 20 is supported by three points, the coupling section 7, the anode output electrode 21a and the cathode output electrode 21b, and the fuel cell section 20 may be held stably in the heat insulating package 10.

As shown in FIG. 5 and FIG. 6, the anode output electrode 21a and the cathode output electrode 21b include bent bending sections 21c and 21d in a space inside the heat insulating package 10 between the wall surface and the fuel cell section 20. These bending sections 21c and 21d relieves the stress which occurs between the fuel cell section 20 and the heat insulating package 10 due to the deformation of the anode output electrode 21a and the cathode output electrode 21b from thermal expansion.

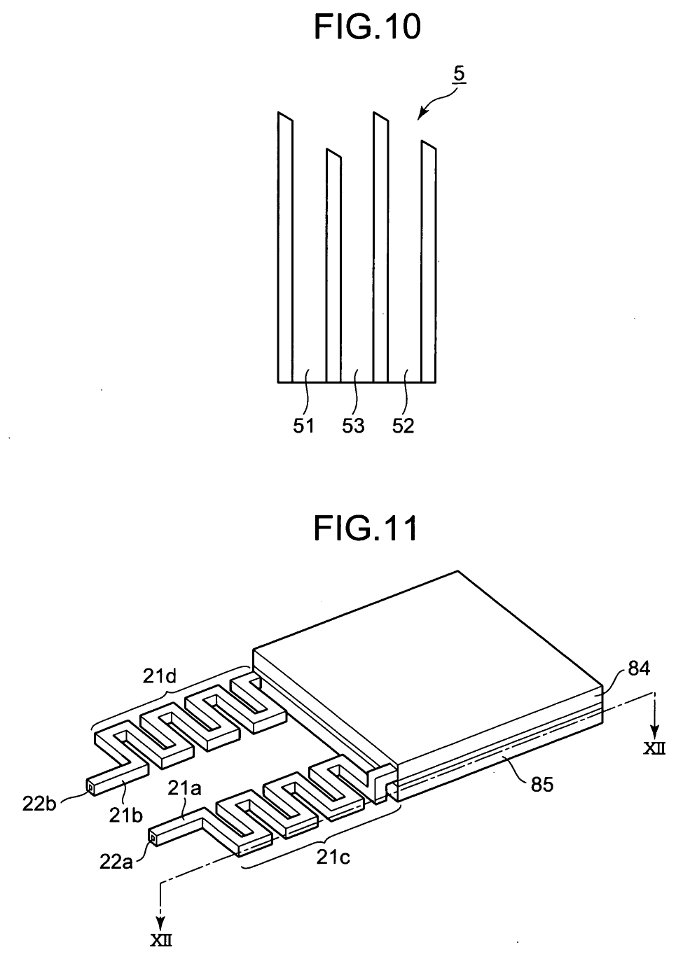

FIG. 11 is a perspective view showing a structure of only an anode output electrode, a cathode output electrode and a power generating cell.

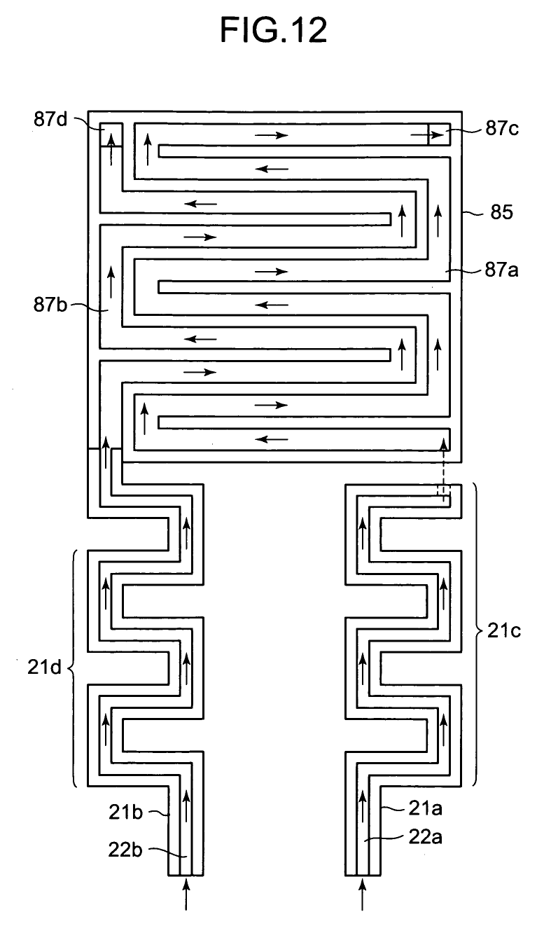

FIG. 12 is a cross-sectional view taken along arrows XII-XII shown in FIG. 11.

The anode output electrode 21a is drawn out from the anode collecting electrode 84 and the cathode output electrode 21b is drawn out from the cathode collecting electrode 85 of the power generating cell 8.

The anode output electrode 21a and the cathode output electrode 21b are hollow tubes and the insides are air supply flow paths 22a and 22b which supply air (oxygen:oxidizing agent) to the oxygen electrode 83 of the power generating cell 8.

As shown in FIG. 12, in the cathode collecting electrode 85, flow paths 87a and 87b are provided in a serpentine shape and connected to the air supply flow path 22a and 22b. The air supply flow path 22a provided in the anode output electrode 21a is connected to the flow path 87a from the anode collecting electrode 84 side through a flow path which penetrates the solid oxide electrolyte 81.

The flow paths 87a and 87b are connected to the air supply flow paths 22a and 22b at one end and the air supplied from the air supply flow paths 22a and 22b are passed through the flow paths 87a and 87b and supplied to the oxygen electrode 83.

On the other ends of the flow paths 87a and 87b, through holes 87c and 87d which lead to the catalytic combustor 9 are provided. The remaining air which was not used in the reaction in the oxygen electrode 83 shown in the chemical reaction formula (3) is supplied to the catalytic combustor 9 through the through holes 87c and 87d.

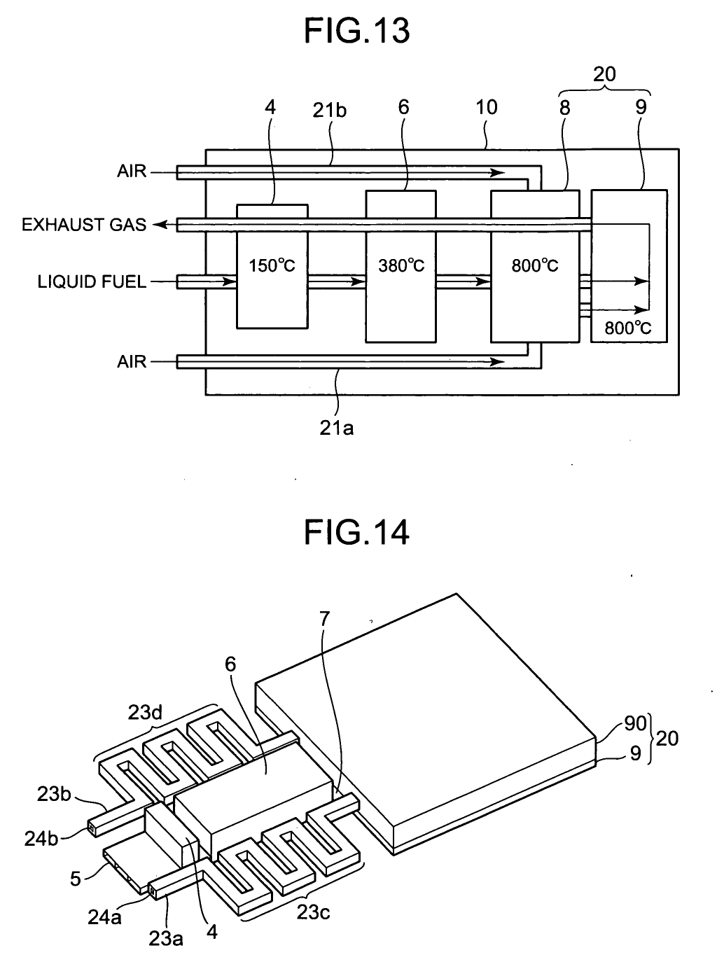

FIG. 13 is a schematic view showing a temperature distribution inside a heat insulating package during normal operation.

As shown in FIG. 13, for example, when the fuel cell section 20 is maintained at about 800° C. the heat transfers from the fuel cell section 20 through the coupling section 7 to the reformer 6, then from the reformer 6 through the coupling section 5 to the vaporizer 4, and finally outside the insulating package 10. As a result, the reformer 6 is maintained at about 380° C. and the vaporizer 4 is maintained at about 150° C.

The heat from the fuel cell section 20 also transfers outside the heat insulating package 10 through the anode output electrode 21a and the cathode output electrode 21b. Thus, after the start-up of the reacting apparatus 1, the output electrodes 21a and 21b extend due to the rise in temperature.

However, in the present embodiment, since air supply flow paths 22a and 22b are provided in the anode output electrode 21a and the cathode output electrode 21b, the anode output electrode 21a and the cathode output electrode 21b can be cooled by supplying air from the air supply flow paths 22a and 22b.

Here, a simulation of the temperature distribution when an air supply flow path was formed in only one output electrode, and an air supply flow path was not formed in the other output electrode was done.

The conditions of the simulation were, the material of the vaporizer 4, the coupling section 5, the reformer 6, the coupling section 7, the box-shaped case 90 storing the power generating cell 8 of the fuel cell section 20 and the catalyst combustor 9 and the output electrode was inconel 783 (resistivity p=1.7×10⁻⁶ [Ω·m]), the length L of the output electrode was 35 mm, degree of vacuum in the heat insulating package 10 was 0.03 Pa, the outer length of the cross section of the output electrode forming the air supply flow path was 0.75 mm×0.75 mm, the inner length thereof was 0.3 mm×0.3 mm, and the outer length of the cross section of the output electrode which do not form the air supply flow path was 0.5 mm×0.5 mm.

The output electric power of the power generating cell 8 was 3 W and the generated electric current I was 500 mA. When a cross section face area of the output electrode is represented by S, the resistance R is represented by the formula ρL/S, and the Joule heat loss I²R from the output electrode can be suppressed to no more than 3% of the output electricity of the power generating cell 8.

A vacuum layer thickness (the shortest distance between the outer surface of the fuel cell section 20 and the inner wall surface of the heat insulating package 10) was 1 mm, an inner size of the heat insulating package 10 was 22.6 mm×14.6 mm×7.6 mm (volume about 2.5 cm³), an outer size of the cross section of the coupling sections 5 and 7 were 2.25 mm×0.5 mm, and an outer size of the cross section of the vaporizer 4 was 1.2 mm×1.2 mm.

As for air from air supply flow path 22a, amount of introduced air was 1.2×10⁻⁴ mol/s and temperature of introduced air was 20° C. (room temperature).

As a result, the temperature of the fuel cell section was 800° C., the temperature of the reformer 6 was 380° C. and the temperature of the vaporizer 4 was 148° C.

The temperature of the end on the heat insulating package 10 side of the output electrode which was supplied with air was 23° C. whereas the temperature of the end on the heat insulating package 10 side of the output electrode which was not supplied with air was 380° C.

As shown above, by providing air supply flow paths 22a and 22b in the anode output electrode 21a and the cathode output electrode 21b, the rise in temperature of the end on the heat insulating package 10 side of the anode output electrode 21a and the cathode output electrode 21b can be suppressed. Thus, a surface temperature of the heat insulating package 10 and the reacting apparatus 1 comprising thereof can be lowered almost to room temperature and therefore can be easily mounted in the electronic device 100. The heat loss from the reacting apparatus 1 to the surrounding circuit substrate can be reduced and therefore the energy efficiency of the entire electronic device 100 can be enhanced.

When the anode output electrode 21a and the cathode output electrode 21b expand and become deformed due to the rise in temperature, since the anode output electrode 21a and the cathode output electrode 21b are connected to the fuel cell section 20 at one end and the inner side wall of the heat insulating package 10 at the other end, the anode output electrode 21a and the cathode output electrode 21b receive stress due to this expansion. However, since the anode output electrode 21a and the cathode output electrode 21b have bending sections 21c and 21d, the bending sections 21c and 21d can absorb the deformations due to the expansion and the stress between the heat insulating package 10 and the fuel cell section 20 may be relieved.

Since the bending sections 21c and 21d are provided, the path of the heat transmission by the anode output electrode 21a and the cathode output electrode 21b become longer, the heat loss which is released from the fuel cell section 20 through the anode output electrode 21a and the cathode output electrode 21b to the heat insulating package 10 can be reduced.

### <Modification 1>

FIG. 14 is a perspective view showing a first modification of an inner structure of the heat insulating package.

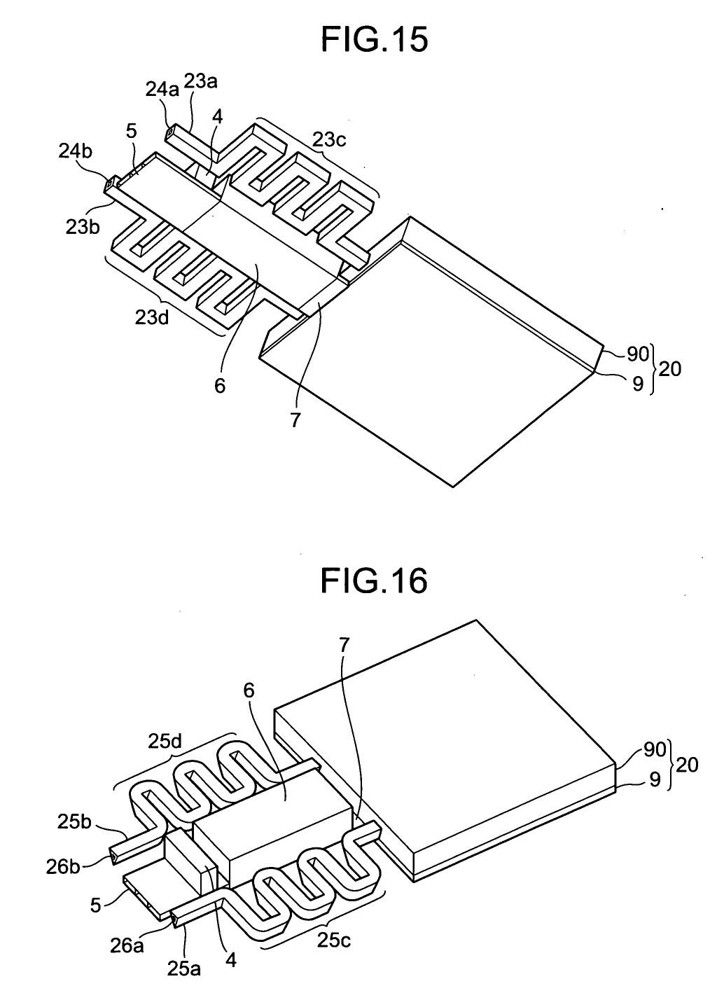

FIG. 15 is a perspective view showing an inner structure of the heat insulating package shown in FIG. 14 viewed from the bottom side.

In the above described embodiment, the anode output electrode 21a and the cathode output electrode 21b are drawn out from diagonal areas on the same face as the face where the coupling section 7 of the fuel cell section 20 is connected. Alternatively, for example, as shown in FIG. 14 and FIG. 15, the number of bends in the bending sections 23c and 23d of the anode output electrode 23a and the cathode output electrode 23b may be adjusted so that the anode output electrode 23a and the cathode output electrode 23b are drawn out from a close area of the connecting area with the coupling section 7 of the fuel cell section 20. The structure of the flow paths 87a and 87b connected to the air supply flow paths 24a and 24b are modified appropriately.

### <Modification 2>

FIG. 16 is a perspective view showing a second modification of an inner structure of the heat insulating package.

In the above described embodiment, the anode output electrode 21a and the cathode output electrode 21b which have rectangular cross sections are used. Alternatively, for example, as shown in FIG. 16, triangular tube shaped anode output electrode 25a and cathode output electrode 25b with bending sections 25c and 25d may be used. The structure of the flow paths 87a and 87b connected to the air supply flow paths 26a and 26b are modified appropriately. Even if the anode output electrode 25a and the cathode output electrode 25b are triangular tube shaped, by supplying air from the air supply flow paths 26a and 26b, the rise in temperature of the end sections on the heat insulating package 10 side of the anode output electrode 25a and the cathode output electrode 25b may be similarly suppressed.

### <Modification 3>

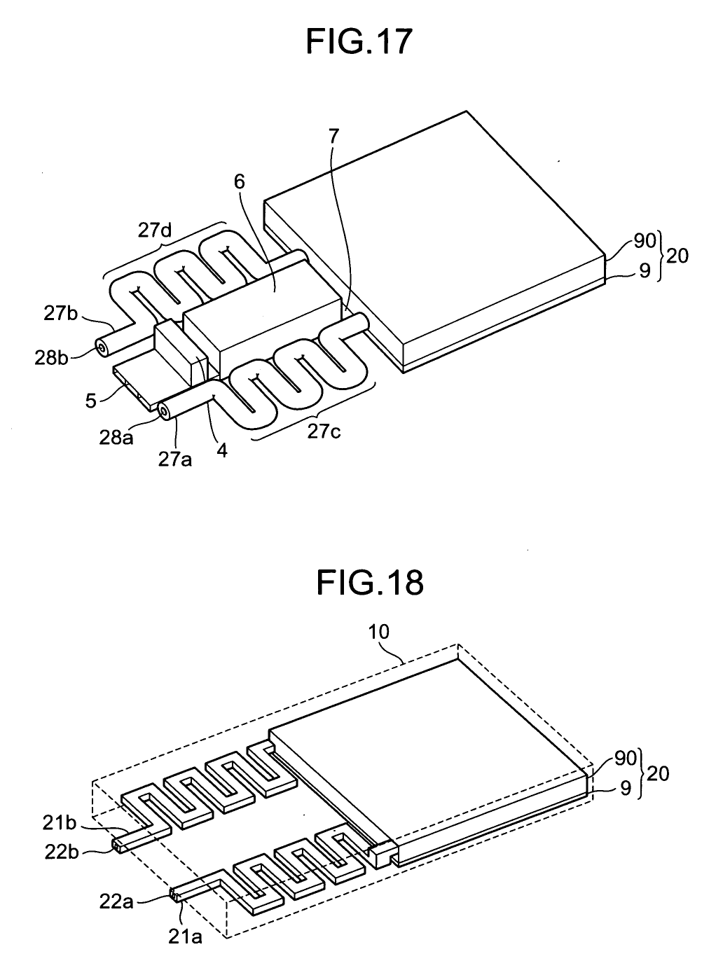

FIG. 17 is a perspective view showing a third modification of an inner structure of the heat insulating package.

In the above described embodiment, the anode output electrode 21a and the cathode output electrode 21b which have rectangular cross sections are used. Alternatively, for example, as shown in FIG. 17, circular tube shaped anode output electrode 27a and cathode output electrode 27b may be used. The structure of the flow paths 87a and 87b connected to the air supply flow paths 28a and 28b are modified appropriately. Even if the anode output electrode 27a and the cathode output electrode 27b are circular tube shaped, by supplying air from the air supply flow paths 28a and 28b, the rise in temperature of the end sections on the heat insulating package 10 side of the anode output electrode 27a and the cathode output electrode 27b may be similarly suppressed.

Also, in the above described embodiment, as shown in FIG. 5 and FIG. 6, the anode output electrode 21a and the cathode output electrode 21b are bent in a right angle to form bending sections 21c and 21d. Alternatively, as shown in FIG. 17, the bent areas in the bending sections 27c and 27d may be bent smoothly in an arc shape. This can prevent the stress from concentrating in the bent areas, and the stress can be spread throughout the entire bending sections 27c and 27d and damage of the anode output electrode 27a and the cathode output electrode 27b due to stress can be prevented.

### Second Embodiment

Next, the second embodiment of the reacting apparatus of the present invention will be described.

FIG. 18 is a perspective view showing an inner structure of the heat insulating package of the reacting apparatus of the second embodiment of the present invention.

Here, the same reference numerals will be applied to the same structures as the above-described first embodiment and the description will be simplified or omitted.

In the reacting apparatus of the above-described first embodiment, the heat insulating package 10 comprises the fuel cell section 20 including the vaporizer 4, the reformer 6, and the power generating cell 8. Alternatively, the reacting apparatus of the second embodiment of the present invention does not comprise a vaporizer 4 and a reformer 6 in a heat insulating package 10.

In other words, as shown in FIG. 18, the reacting apparatus of the present invention includes a fuel cell section 20, an anode output electrode 21a and a cathode output electrode 21b in the heat insulating package 10. One of the ends of the anode output electrode 21a and the cathode output electrode 21b are connected to the fuel cell section 20.

The present embodiment is for structures where the reformer 6 is provided outside the heat insulating package 10, and the gas mixture (reformed gas) as fuel generated by the reformer is supplied from outside the heat insulating package 10 or the hydrogen gas as fuel is directly supplied from outside the heat insulating package 10.

Here, flow paths 22a and 22b are provided inside the anode output electrode 21a and the cathode output electrode 21b. For example, air (oxygen: oxidizing agent) may be supplied to the oxygen electrode 83 of the power generating cell 8 through one of the flow paths 22a or 22b, and reformed gas or hydrogen gas as fuel may be supplied to the fuel electrode 82 of the power generating cell 8 through the other one of the flow paths 22a or 22b. Alternatively, the reformed gas or hydrogen gas as fuel may be supplied to the fuel electrode 82 through one or both of the flow paths 22a and 22b and the air may be supplied to the oxygen electrode 83 through another flow path which is not shown.

Even with this embodiment, the rise in temperature of the other end side of the anode output electrode 21a and the cathode output electrode 21b can be suppressed, and therefore the reacting apparatus can be easily mounted in the electronic device 100. The heat loss from the reacting apparatus 1 to the surrounding circuit substrate can be reduced and therefore the energy efficiency of the entire electronic device 100 can be enhanced.

### Third Embodiment

Next the third embodiment of the reacting apparatus of the present invention will be described.

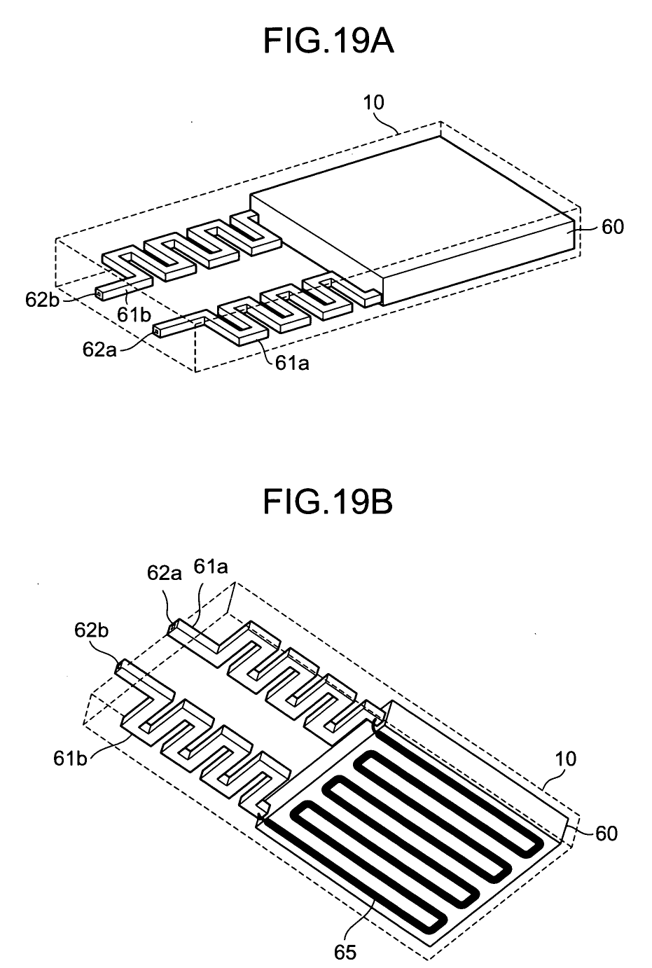

FIG. 19 is a perspective view showing an inner structure of the heat insulating package 10 of the reacting apparatus of the third embodiment of the present invention.

In the above-described first and second embodiments, the heat insulating package 10 includes the fuel cell section 20 including the power generating cell 8 and the generated electric power is output from the power generating cell 8 through the anode output electrode 21a and the cathode output electrode 21b where one side is connected to the fuel cell section 20. However, the present invention is not limited to this structure, and can be favorably applied to a structure where a reactor, in which a reactant is supplied and heated to a predetermined temperature so that the supplied reactant causes a reaction, is included in the heat insulating package 10.

In other words, as shown in FIG. 19, the reacting apparatus of this embodiment includes a reactor 60 in which a reactant is supplied and heated to a predetermined temperature so that the supplied reactant causes a reaction in the heat insulating package 10 and electrically conductive components 61a and 61b which are connected to the reactor 60 at one end. Flow paths 62a and 62b are provided in the electrically conductive components 61a and 61b.

For example, the same structure as the reformer 6 in the above-described first embodiment may be applied as the reactor 60. In such reactor 60, in order to cause a reaction of the supplied reactant, or a reforming reaction when it is a reformer, it is necessary to heat and set to a desired reacting temperature. Thus, an electric heater 65 for heating is provided. For example, the electrically conductive components 61a and 61b are connected to both ends of the electric heater 65, and are used for input electrodes to supply currents to the electric heater 65.

The reactants are supplied to the reactor 60 through the flow paths 62a and 62b provided inside the electrically conductive components 61a and 61b. For example, when the reactor 60 is the reformer, the gas mixture vaporized in the vaporizer may be supplied to the reactor 60 through one or both of the flow paths 62a and 62b inside the electrically conductive components 61a and 61b. Alternatively, the gas mixture may be supplied to the reactor 60 through one or both of the flow paths 62a and 62b and the gas mixture (reformed gas) generated by the reformer can be discharged through the other flow path.

Even with this embodiment, the rise in temperature of the other end side of the electrically conductive components 61a and 61b can be suppressed, and therefore the reacting apparatus can be easily mounted in the electronic device 100. The heat loss from the reacting apparatus 1 to the surrounding circuit substrate can be reduced and therefore the energy efficiency of the entire electronic device 100 can be enhanced.

The entire disclosure of Japanese Patent Application No. 2007-29215 on Feb. 8, 2007 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A reacting apparatus comprising:
a reactor including a reacting section to which a reactant is supplied to cause a reaction of the reactant;
one or a plurality of terminal section provided in the reacting section; and
one or a plurality of conductive component including electrically conductive material, one end of which is connected to any one of the terminal section of the reactor,
wherein
at least one of the conductive component has a flow path provided inside thereof; and
at least a portion of the reactant is supplied to the reactor through the flow path.

2. The reacting apparatus according to claim 1, wherein a cross section of the conductive component orthogonal to an extending direction is any one of rectangular, triangular or circular.

3. The reacting apparatus according to claim 1, wherein the conductive component includes a stress relieving structure with at least one of bending sections.

4. The reacting apparatus according to claim 3, further comprising a heat insulating container which accommodates the reactor in which a pressure inside is lower than atmospheric pressure, wherein
the other end of the conductive component is drawn outside from the wall surface of the heat insulating container, and
the stress relieving structure is provided inside the heat insulating container between the wall surface and the terminal section of the reactor.

5. The reacting apparatus according to claim 3, wherein the conductive component is bent in a serpentine shape in the stress relieving structure.

6. The reacting apparatus according to claim 1, wherein
the reactant includes fuel and an oxidizing agent,
the reactor includes a power generating cell to generate electric power with an electrochemical reaction of the fuel and the oxidizing agent,
the terminal section is a positive output terminal and a negative output terminal to output the electric power generated in the power generating cell,
the conductive component is an output electrode, one end of which is connected to the positive output terminal or the negative output terminal, and the electric power generated in the power generating cell is output from the other end, and
at least one of the output electrode has the flow path inside thereof and at least one of the fuel and the oxidizing agent is supplied to the power generating cell through the flow path.

7. The reacting apparatus according to claim 6, wherein a solid oxide electrolyte is used in the power generating cell.

8. The reacting apparatus according to claim 6, wherein the reactor further includes a combustor to burn an unreacted fuel gas discharged from the electric power generation cell to heat the electric power generation cell.

9. The reacting apparatus according to claim 6, further comprising a heat insulating container which accommodates the power generating cell and where a pressure inside is lower than atmospheric pressure, and wherein the other end of the output electrode is drawn outside from a wall surface of the heat insulating container.

10. The reacting apparatus according to claim 9, further comprising a reformer, which is accommodated in the heat insulating container, and to which a raw fuel having a composition including hydrogen is supplied to generate the fuel from the raw fuel with heat propagated from the power generating cell.

11. The reacting apparatus according to claim 9, further comprising,
a reformer, which is accommodated in the heat insulating container, and to which a raw fuel having a composition including hydrogen is supplied to generate the fuel from the raw fuel with heat propagated from the power generating cell;
a first coupling section provided with a flow path to supply the raw fuel to the reformer from outside, in which one end penetrates a wall surface of the heat insulating container and is drawn outside and the other end is connected to the reformer; and
a second coupling section provided with a flow path to supply the fuel generated by the reformer to the power generating cell, in which one end is connected to the reformer, and the other end is connected to the power generating cell, wherein
the oxidizing agent is supplied to the power generating cell through the flow path of the output electrode.

12. The reacting apparatus according to claim 11, wherein the raw fuel is a liquid, and in the first coupling section a vaporizer is provided to vaporize the raw fuel with the heat propagated from the reformer and to supply the vaporized raw fuel to the reformer.

13. The reacting apparatus according to claim 11, wherein the first coupling section, the reformer, the second coupling section and the output electrode are formed from Ni-based alloy.

14. A reacting apparatus comprising:
a heat insulating container in which a pressure inside is lower than atmospheric pressure;
a reactor which is accommodated in the heat insulating container and including a reacting section to which a reactant is supplied to cause a reaction of the reactant;
one or a plurality of terminal section provided in the reacting section; and
one or a plurality of conductive component including electrically conductive material, one end of the conductive component being connected to any one of the terminal section of the reactor and the other end is drawn outside from a wall surface of the heat insulating container,
wherein
at least one of the conductive component has a flow path provided inside thereof; and
at least a portion of the reactant is supplied to the reactor through the flow path.

15. The reacting apparatus according to claim 14, wherein the conductive component includes a stress relieving structure with at least one of bending sections which is provided inside the heat insulating container between the wall surface and the terminal section of the power generating cell.

16. The reacting apparatus according to claim 14, wherein
the reactant includes fuel and an oxidizing agent,
the reformer includes a power generating cell to generate electric power with an electrochemical reaction of the fuel and the oxidizing agent,
the terminal section is a positive output terminal and a negative output terminal to output the electric power generated in the power generating cell,
at least one of the conductive component is an output electrode, one end of which is connected to the positive output terminal or the negative output terminal, and the electric power generated in the power generating cell is output from the other end, and
at least one of the output electrode has the flow path inside thereof and at least one of the fuel and the oxidizing agent is supplied to the power generating cell through the flow path.

17. The reacting apparatus according to claim 16, wherein the reactor includes a reformer to which a raw fuel having a composition including hydrogen is supplied to generate the fuel from the raw fuel with heat propagated from the power generating cell.

18. The reacting apparatus according to claim 16, further comprising,
a reformer, which is accommodated in the heat insulating container, and to which a raw fuel having a composition including hydrogen is supplied to generate the fuel from the raw fuel with heat propagated from the power generating cell;
a first coupling section provided with a flow path to supply the raw fuel to the reformer from outside, in which one end penetrates a wall surface of the heat insulating container and is drawn outside and the other end is connected to the reformer; and
a second coupling section provided with a flow path to supply the fuel generated by the reformer to the power generating cell, in which one end is connected to the reformer, and the other end is connected to the power generating cell, and wherein
the oxidizing agent is supplied to the power generating cell through the flow path of the output electrode.

19. The reacting apparatus according to claim 16, wherein a solid oxide electrolyte is used in the power generating cell.

20. An electronic device, comprising:
a power generating cell to which fuel and an oxidizing agent is supplied to generate electric power with an electrochemical reaction of the fuel and the oxidizing agent, and which includes a positive output terminal and a negative output terminal to output the generated electric power;
a plurality of output electrodes to output electric power generated in the power generating cell, each of which includes electrically conductive material, one end of each of which is connected to the positive output terminal or the negative output terminal; and
a load driven by the electric power output from the output electrodes, wherein
at least one of the output electrodes has a flow path provided inside thereof to supply at least one of the fuel and the oxidizing agent to the power generating cell.

21. The electronic device according to claim 20, further comprising a heat insulating container which accommodates the power generating cell and where a pressure inside is lower than atmospheric pressure, wherein the other end of the output electrode is drawn outside from a wall surface of the heat insulating container.

22. The electronic device according to claim 21, wherein the output electrode includes a stress relieving structure with at least one of bending sections inside the heat insulating container between the wall surface and the terminal section of the power generating cell.

23. The electronic device according to claim 21, wherein a solid oxide electrolyte is used in the power generating cell.

24. The electronic device according to claim 21, further comprising a reformer, accommodated in the heat insulating container, to which a raw fuel having a composition including hydrogen is supplied to generate the fuel from the raw fuel with heat propagated from the power generating cell.

25. The electronic device according to claim 21, further comprising,
a reformer, which is accommodated in the heat insulating container, and to which a raw fuel having a composition including hydrogen is supplied to generate the fuel from the raw fuel with heat propagated from the power generating cell;
a first coupling section provided with a flow path to supply the raw fuel to the reformer, in which one end penetrates the wall surface of the heat insulating container and is drawn outside and the other end is connected to the reformer; and
a second coupling section provided with a flow path to supply the fuel generated by the reformer to the power generating cell, in which one end is connected to the reformer, and the other end is connected to the power generating cell, wherein
the oxidizing agent is supplied to the power generating cell through the flow path of the output electrode.

26. The reforming apparatus according to claim 1, wherein
the reactant includes raw fuel having a composition including hydrogen,
the reactor includes a reformer to generate fuel including a hydrogen molecule from the raw fuel and an electric heater to heat the reformer,
the terminal section is input terminals provided on both ends of the electric heater,
the conductive component is an input electrode, one end of which is connected to one of the input terminals, and the other end of which supplies electric power to the electric heater,
at least one of the input electrode has a flow path provided inside thereof, and
the raw fuel is supplied to the reformer through the flow path.
